(19) United States
(12) Patent Application Publication
(10) Pub. No.: US 2026/0203755 A1
(43) Pub. Date: Jul. 16, 2026

(54) Method and System for Automatic Payment Method Transmission to Merchants

(71) Applicant: Visa International Service Association, San Francisco, CA (US)

(72) Inventor: Jaimini Ram, Bangalore (IN)

(21) Appl. No.: 19/135,612

(22) PCT Filed: Dec. 5, 2022
(86) PCT No.: PCT/IB2022/061765

§ 371 Date: Jun. 4, 2025

(51) Int. Cl. G06Q 20/38

(52) U.S. Cl. CPC G06Q 20/386

(57) ABSTRACT

The present disclosure relates to a payment processing system and a method for automatic payment method transmission to merchants. The method comprises providing a list of plurality of merchants to a user for receiving a user selection on at least one of the plurality of merchants for performing one or more transactions. In response to the user selection, the method comprises authenticating the user, based on user details provided by the user, for authorizing the user to set one or more payment methods for the at least one of the plurality of merchants selected by the user. Subsequently, method comprises transmitting the user details, user authorization and the one or more payment methods set by the user to a payment processor associated with each of the plurality of merchants selected by the user. Finally, the method comprises receiving a merchant confirmation on acceptance of the one or more payment methods set by the user from the at least one of the plurality of merchants selected by the user. In some embodiments, the above process may be also used to delete the one or more payment methods set with the plurality of merchants selected by the user and/or delete a merchant from the list of the plurality of merchants selected by the user.

### CROSS REFERENCE TO RELATED APPLICATION

This application is the United States national phase of International Application No. PCT/IB2022/061765, filed Dec. 5, 2022, the disclosure of which is hereby incorporated by reference in its entirety.

### BACKGROUND

### Technical Field

The present disclosure relates to electronic transactions. Particularly, but not exclusively, the present disclosure relates to a system and a computer implemented method for automatic payment method transmission to merchants.

### Technical Considerations

Currently, when a user gets a new credit card, the user must manually add the card details on an online merchant platform before performing a transaction. This causes inconvenience to the user, as the user needs to perform these steps in every merchant platform that the user performs a transaction. Similarly, when the card is expired and/or a new card is issued to the user, the user must manually enter the details again. This causes a friction between the user and the merchants during the payment lifecycle.

On the other hand, storing the payment details on the merchant platform has a higher possibility of multiple attacks, such as shoulder surfing, and the details getting stolen. Thus, the existing approaches cause inconvenience to either the merchant or the user who is making the payment. Therefore, there exists need for a simple and convenient method for automatic payment method transmission to the merchants.

The information disclosed in this background of the disclosure section is only for enhancement of understanding of the general background of the disclosure and should not be taken as an acknowledgement or any form of suggestion that this information forms the existing technology.

### SUMMARY

Additional features and advantages are realized through the techniques of the present disclosure. Other non-limiting embodiments and aspects of the disclosure are described in detail herein and are considered a part of the claimed disclosure.

Disclosed herein is a computer-implemented method for automatic payment method transmission to merchants, the method may include: providing a list of a plurality of merchants to a user for receiving a user selection on at least one of the plurality of merchants for performing one or more transactions. Further, the method may include authenticating the user, based on user details provided by the user, for authorizing the user to set one or more payment methods for the at least one of the plurality of merchants selected by the user. Furthermore, the method may include transmitting the user details, user authorization and the one or more payment methods set by the user to a payment processor associated with each of the plurality of merchants selected by the user. Finally, the method may include receiving a merchant confirmation on acceptance of the one or more payment methods set by the user from the at least one of the plurality of merchants selected by the user.

Further, in a non-limiting embodiment, the present disclosure may include a payment processing system. The payment processing system may include a processor and a memory. The memory may be communicatively coupled to the processor and store processor-executable instructions, which, on execution, cause the processor to provide a list of a plurality of merchants to a user for receiving a user selection on at least one of the plurality of merchants for performing one or more transactions. Further, the instructions may cause the processor to authenticate the user, based on user details provided by the user, for authorizing the user to set one or more payment methods for the at least one of the plurality of merchants selected by the user. Furthermore, the instructions may cause the processor to transmit the user details, user authorization and the one or more payment methods set by the user to a payment processor associated with each of the plurality of merchants selected by the user. Finally, the instructions may cause the processor to receive a merchant confirmation on acceptance of the one or more payment methods set by the user from the at least one of the plurality of merchants selected by the user.

Further, in a non-limiting embodiment, the present disclosure may include a non-transitory computer readable medium including instructions stored thereon that when processed by at least one processor causes a payment processing system to perform operations including providing a list of a plurality of merchants to a user for receiving a user selection on at least one of the plurality of merchants for performing one or more transactions. Further, the instructions cause the payment processing system to authenticate the user, based on user details provided by the user, for authorizing the user to set one or more payment methods for the at least one of the plurality of merchants selected by the user. Furthermore, the instructions may cause the payment processing system to transmit the user details, user authorization and the one or more payment methods set by the user to a payment processor associated with each of the plurality of merchants selected by the user. Finally, the instructions may cause the payment processing system to receive a merchant confirmation on acceptance of the one or more payment methods set by the user from the at least one of the plurality of merchants selected by the user.

Disclosed herein is a computer-implemented method for automatic payment method transmission to merchants, the method may include: providing a list of a plurality of merchants to a user for providing a list of plurality of merchants to a user for receiving a user selection on at least one of the plurality of merchants for deleting one or more payment methods set to the plurality of merchants. Further, the method may include authenticating the user based on user details provided by the user for authorizing the user to delete the one or more payment methods for the at least one of the plurality of merchants selected by the user. Furthermore, the method may include transmitting the user details, user authorization and the one or more payment methods to be deleted to a payment processor associated with each of the plurality of merchants selected by the user. Finally, the method may include receiving a merchant confirmation on deletion of the one or more payment methods from the at least one of the plurality of merchants selected by the user.

Further, in a non-limiting embodiment, the present disclosure may include a payment processing system. The payment processing system may include a processor and a memory. The memory may be communicatively coupled to the processor and store processor-executable instructions, which, on execution, cause the processor to provide a list of a plurality of merchants to a user for receiving a user selection on at least one of the plurality of merchants for deleting one or more payment methods set to the plurality of merchants. Further, the instructions may cause the processor to authenticate the user based on user details provided by the user for authorizing the user to delete the one or more payment methods for the at least one of the plurality of merchants selected by the user. Furthermore, the instructions may cause the processor to transmit the user details, user authorization and the one or more payment methods to be deleted to a payment processor associated with each of the plurality of merchants selected by the user. Finally, the instructions may cause the processor to receive a merchant confirmation on deletion of the one or more payment methods from the at least one of the plurality of merchants selected by the user.

Further, in an embodiment, the present disclosure may include a non-transitory computer readable medium including instructions stored thereon that when processed by at least one processor causes a payment processing system to perform operations including providing a list of a plurality of merchants to a user for receiving a user selection on at least one of the plurality of merchants for deleting one or more payment methods set to the plurality of merchants. Further, the instructions cause the payment processing system to authenticate the user based on user details provided by the user for authorizing the user to delete the one or more payment methods for the at least one of the plurality of merchants selected by the user. Furthermore, the instructions may cause the payment processing system to transmit the user details, user authorization and the one or more payment methods to be deleted to a payment processor associated with each of the plurality of merchants selected by the user. Finally, the instructions may cause the payment processing system to receive a merchant confirmation on deletion of the one or more payment methods from the at least one of the plurality of merchants selected by the user.

The foregoing summary is illustrative only and is not intended to be in any way limiting. In addition to the illustrative aspects, embodiments, and features described above, further aspects, embodiments, and features may become apparent by reference to the drawings and the following detailed description.

### BRIEF DESCRIPTION OF THE DRAWINGS

The novel features and characteristic of the disclosure are set forth in the appended claims. The disclosure itself, however, as well as a preferred mode of use, further objectives and advantages thereof, may best be understood by reference to the following detailed description of an illustrative embodiment when read in conjunction with the accompanying drawings. The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. One or more embodiments are now described, by way of example only, with reference to the accompanying figures wherein like reference numerals represent like elements and in which:

FIG. 1 shows an exemplary environment illustrating a method for automatic payment method transmission to merchants in accordance with some non-limiting embodiments of the present disclosure;

FIG. 2 shows a detailed block diagram of a payment processing system in accordance with some non-limiting embodiments of the present disclosure;

FIGS. 3A and 3B show flowcharts illustrating methods for automatic payment method transmission to merchants, in accordance with some non-limiting embodiments of the present disclosure;

FIG. 4 shows an exemplary scenario illustrating authentication of the user in accordance with some non-limiting embodiments of the present disclosure; and

FIG. 5 is a block diagram of an exemplary computer system for implementing non-limiting embodiments consistent with the present disclosure.

It should be appreciated by those skilled in the art that any block diagrams herein represent conceptual views of illustrative systems embodying the principles of the present subject matter. Similarly, it may be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and may be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “includes” “comprising”, “including” or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” or “includes . . . a” does not, without more constraints, preclude the existence of other elements or additional elements in the system or apparatus.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” or “computer system” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices/systems or combinations of computing devices/systems and/or components of such (e.g., processors, servers, client devices, software applications, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

The term “configured to” or “configured for,” as used herein, may refer to an arrangement of software, device(s), and/or hardware for performing and/or enabling one or more functions (e.g., actions, processes, steps of a process, and/or the like).

The present disclosure relates to a payment processing system and a computer implemented method for automatic payment method transmission to merchants. In some non-limiting embodiments, the method comprises providing a list of plurality of merchants to a user for receiving a user selection on at least one of the plurality of merchants for performing one or more transactions. In response to the user selection, the method comprises authenticating the user, based on user details provided by the user, for authorizing the user to set one or more payment methods for the at least one of the plurality of merchants selected by the user. Subsequently, method comprises transmitting the user details, user authorization and the one or more payment methods set by the user to a payment processor associated with each of the plurality of merchants selected by the user. Finally, the method comprises receiving a merchant confirmation on acceptance of the one or more payment methods set by the user from the at least one of the plurality of merchants selected by the user.

In some non-limiting embodiments, the payment processing system and the computer-implemented method of the present disclosure provide a convenient way for the users to perform a transaction on the merchant platform. Moreover, the present disclosure proposes to store the card details on a payment processing system, thereby reducing the workload on a payment processor associated with the merchant. Further, the present disclosure helps merchants reduce the costs associated with authenticating the users. Also, according to the present disclosure, the user details and transaction details are stored with the issuer, which helps in eliminating the risks associated with the transaction.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

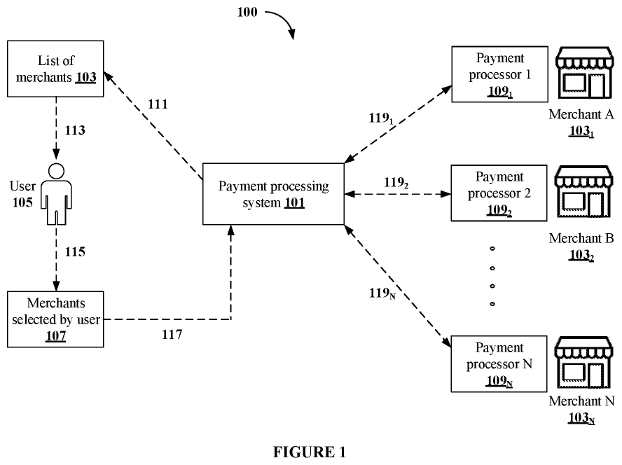

FIG. 1 shows an exemplary environment illustrating a method for automatic payment method transmission to merchants in accordance with some non-limiting embodiments of the present disclosure.

In some implementations, the environment 100 may include a plurality of merchants, namely merchant A 103A, merchant B 103B, . . . , merchant N 103N (collectively referred to as plurality of merchants 103) associated with one or more payment processors 109, namely payment processor 1 1091, . . . , payment processor N 109N (collectively referred as payment processors 109), a user 105 and a payment processing system 101. As an example, the user 105 may be registered with the payment processing system 101 and intend to perform one or more transactions with the at least one of the plurality of merchants 103. The plurality of merchants 103 may be preregistered with the payment processing system.

In some non-limiting embodiments, the payment processing system 101 may be a computing system configured to perform a technical process comprising providing a list of plurality of merchants 103 to a user 105, authenticating the user 105, transmitting the user details, user authorization and the one or more payment methods set by the user 105 to the payment processors 109 and receive a merchant confirmation from the merchants 103. Here, the payment processing system 101 may be an issuer entity such as, without limiting to, a bank, a payment gateway, a payment server and the like. In some non-limiting embodiments, the user 105 may interact with the payment processing system 101 using a medium such as, for example, a mobile application installed on a computing device of the user 105 and/or a web application. As an example, the computing device may include, without limiting to, a smartphone, a Personal Digital Assistant (PDA) or a desktop computer.

In some non-limiting embodiments, the user 105 may be provided a list of plurality of merchants 103, as indicated in step 111, for receiving a user selection 107 on at least one of the plurality of merchants 103. In some non-limiting embodiments, the 103 may be displayed to the user 105 on a computing system associated with the user 105. As an example, the computing system associated with the user 105 may include, without limiting to, a smartphone, a Personal Digital Assistant (PDA) or a desktop computer. In some non-limiting embodiments, the plurality of merchants 103 may be preregistered with the payment processing system 101 to perform the one or more transactions initiated by the user 105 on the merchant platform. In some non-limiting embodiments, the plurality of merchants 103 may be authenticated by the payment processing system 101 before providing the list of plurality of merchants 103 to the user 105. In some non-limiting embodiments, along with the list of merchants 103, the payment processing system 101 may also provide information related to types of payment methods accepted by the merchant 103 along with the merchant details to the user 105. In some non-limiting embodiments, the types of payment methods may include, without limitation, a card-based transaction, a Unified Payments Interface (UPI) transaction, a crypto-based transaction and the like.

In some non-limiting embodiments, upon receiving the user selection 107, the payment processing system 101 may authenticate the user 105, based on user details provided by the user 105, for authorizing the user 105 to set one or more payment methods for the at least one of the plurality of merchants selected by the user 107. In some non-limiting embodiments, the user details may include preregistered user credentials such as, without limitation, a name of the user 105, a phone number of the user 105, a credit card and/or debit card number, a UPI identifier (ID), a crypto wallet ID, an email ID preregistered with the merchants, a username registered at the merchant platform and the like. As an example, to authenticate the user 105, the payment processing system 101 may send a One Time Password (OTP) to the user 105 on the registered phone number and/or the registered email ID of the user. As an example, when the user 105 selects the card transaction as a payment method, the payment processing system 101 may request the user 105 to provide the card details such as card number, name on the card, month and year of expiry of the card, Card Verification Value (CVV), Personal Identification Number (PIN) and the like.

Subsequently, the payment processing system 101 may validate the one or more payment methods set by the user 103 based on the details related to the one or more payment methods.

In some non-limiting embodiments, upon authenticating the user 105, the payment processing system 101 may transmit the user details, user authorization and the one or more payment methods set by the user 105 to a payment processor 109 associated with each of the plurality of merchants 103 selected by the user 107. In some non-limiting embodiments, the payment processor 109 associated with the each of the plurality of merchants 103 may be a computing system such as, without limiting to, a desktop computer or a server computing system. Here, the payment processor 109 associated with each of the plurality of merchants 103 may be an issuer entity associated with the plurality of merchants 103 such as, without limiting to, a bank, a payment gateway, a payment server and the like. In some non-limiting embodiments, the user details transmitted to the payment processors 109 may comprise the details used by the user 105 to register with the merchants 103 In some non-limiting embodiments, the payment processing system 101 may generate a token using a predefined technique for the details related to the one or more payment methods set by the user 105. Subsequently, the payment processing system 101 may transmit the token to each of the plurality of merchants 103 selected by the user 107.

In some non-limiting embodiments, after transmitting the user details, user authorization and the one or more payment methods, the payment processing system 101 may receive a merchant confirmation on acceptance of the one or more payment methods set by the user 105 from the at least one of the plurality of merchants 103 selected by the user 107. In some non-limiting embodiments, the merchant confirmation is received when the user details provided by the user 105 matches with preregistered user details stored with the at least one of the plurality of merchants 103 selected by the user 107. In some non-limiting embodiments, the merchant confirmation is generated upon successful authentication of the user 105 by the payment processor 109 associated with the at least one of the plurality of merchants 103 selected by the user 107. In some non-limiting embodiments, upon receiving the merchant confirmation, the user 105 may initiate the one or more transactions with the at least one of the plurality of merchants 103 selected by the user 107 without having to repetitively enter the details related to the one or more payment methods on the merchant platform.

In some non-limiting embodiments, a similar process may be performed when the user 105 wants to add a new merchant in the list of plurality of merchants 103 previously selected by the user 105. In such instances, the payment processing system 101 may dynamically revalidate the one or more payment methods upon detecting a change in the details related to the one or more payment methods. Further, as an example, when the card of the user 105 is expired, the payment processing system 101 may delete the existing card details and revalidate the details related to the new card. Upon validating the new card details, the payment processing system 101 may add and store the new card details. In some non-limiting embodiments, the user 105 may re-attempt the automatic payment method transmission for the at least one of the plurality of merchants 103 when the one or more payment methods set by the user 105 is not accepted by the at least one of the plurality of merchants 103. In some non-limiting embodiments, when the one or more payment methods set by the user 105 is not accepted by the at least one of the plurality of merchants 103, the user 105 may repeat the process and select a new payment method with the merchant.

In some non-limiting embodiments, a user 105 may also delete the one or more payment methods set with the plurality of merchants 103. In some non-limiting embodiments, the payment processing system 101 may provide a list of the plurality of merchants 103 to the user 105 for receiving a user selection 107 on at least one of the plurality of merchants 103 for deleting the one or more payment methods set to the plurality of merchants 103.

In some non-limiting embodiments, upon receiving the user selection 107, the payment processing system 101 may authenticate the user 105 based on user details provided by the user 105 before deleting the one or more payment methods for the at least one of the plurality of merchants selected by the user 107.

In some non-limiting embodiments, upon authenticating the user 105 the payment processing system 101 may transmit the user details, user authorization and the one or more payment methods to be deleted to a payment processor 109 associated with each of the plurality of merchants selected by the user 107.

Subsequently, the payment processing system 101 may receive a merchant confirmation on deletion of the one or more payment methods from the at least one of the plurality of merchants selected by the users 105. In some non-limiting embodiments, the payment processor 109 may delete the details related to the one or more payment methods set by the user 105. In some non-limiting embodiments, payment processing system 101 may forward the confirmation to the user 105 upon successful deletion of the one or more payment methods set by the user 105.

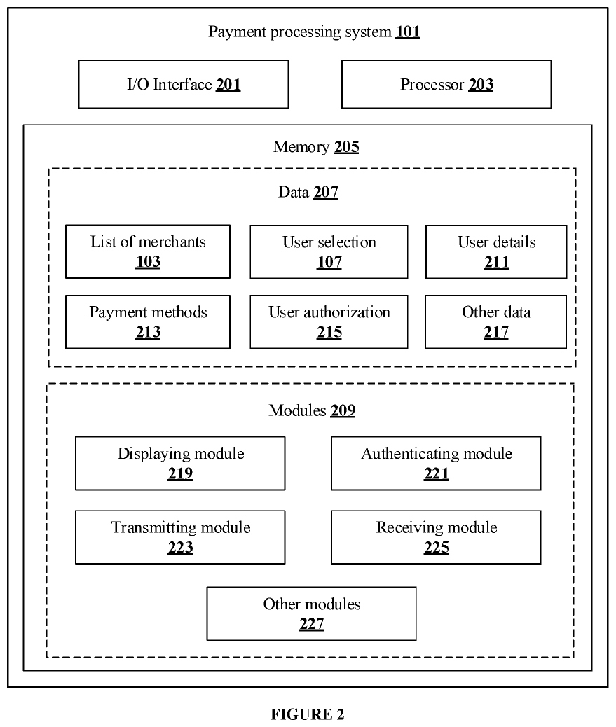

FIG. 2 shows a detailed block diagram of a payment processing system 101 in accordance with some non-limiting embodiments of the present disclosure.

In some implementations, the payment processing system 101 may include a processor 203, a I/O interface 201 and a memory 205. The processor 203 may be used to perform various functions of the payment processing system 101 using the data and the modules stored in the memory 205. The I/O interface 201 may be used for interfacing the payment processing system 101 with one or more external computing devices, for example, a smartphone of the user 105 for receiving a user selection 107 on at least one of the plurality of merchants 103 for performing one or more transactions. In some non-limiting embodiments, the data 207 may be stored in a memory 205 of the payment processing system 101 as shown in the FIG. 2. As an example, the data 207 may include a list of plurality of merchants 103, a user selection 107, user details 211, payment methods 213, a user authorization 215 and other data 217.

In some non-limiting embodiments, the data 207 may be stored in the memory 205 in form of various data structures. Additionally, the data 207 can be organized using data models, such as relational or hierarchical data models. The other data 215 may store data, including temporary data and temporary files, generated by the modules 209 for performing the various functions of the payment processing system 101.

In some non-limiting embodiments, the list of plurality of merchants 103 may be the names and details of the merchants provided to the user 105 for receiving the user's confirmation on the list of plurality of merchants 103 selected by the user 105. In some non-limiting embodiments, each merchant in the list of the plurality of the merchants 103 may have preregistered with the payment processing system 101.

In some non-limiting embodiments, the user selection 107 may be at least one of plurality of merchants selected by a user 105 from a list of plurality of merchants 103. In some non-limiting embodiments, the user selection 107 may also include names or identities of the merchants that the user 105 has selected for deleting the one or more payment methods 213.

In some non-limiting embodiments, the user details 211 may be details received from the user 105 and may be used for authorizing the user 105 to set one or more payment methods 213 and/or to delete the one or more payment methods 213 for the at least one of the plurality of merchants selected by the user 107. In some non-limiting embodiments, the user details 211 may comprise, without limitation, a name of the user 105, a phone number of the user 105, a credit card and/or debit card number, a Unified Payments Interface (UPI) Identifier (ID), a crypto wallet ID, an email ID etc., which are preregistered with the merchants. In some non-limiting embodiments, the user details 211 may be transmitted to a payment processor 109 associated with each of the plurality of merchants selected by the user 107.

In some non-limiting embodiments, the one or more payment methods 213 may be the payment means set by the user 105 to perform one or more transactions. In some non-limiting embodiments, the one or more payment methods 213 may comprise, without limitation, a card-based transaction, an UPI transaction, a crypto-based transaction and the like. In some non-limiting embodiments, the one or more payment methods 213 may be transmitted to the payment processor 109 associated with each of the plurality of merchants selected by the user 107.

In some non-limiting embodiments, the user authorization 215 may be an authorization performed by the payment processing system 101 using the user details 211 provided by the user 105. In some non-limiting embodiments, the user authorization may be transmitted to the payment processor 109 associated with each of the plurality of merchants selected by the user 107.

In some non-limiting embodiments, each of the data 207 stored in the memory 205 may be processed by the modules 209 of the payment processing system 101. The modules 209 may be stored within the memory 205. In an example, the modules 209 may be communicatively coupled to the processor 203 configured in the payment processing system 101. Alternatively, the modules 209 may also be present outside the memory 205 as shown in FIG. 2 and implemented as individual hardware components. As used herein, the term modules 209 may refer to an Application Specific Integrated Circuit (ASIC), an electronic circuit, a processor (shared, dedicated, or group) and memory that execute one or more software or firmware programs, a combinational logic circuit, and/or other suitable components that provide the described functionality.

In some non-limiting embodiments, the modules 209 may include, for example, a displaying module 219, an authenticating module 221, a transmitting module 223, a receiving module 225 and other modules 227. The other modules 227 may be used to perform various miscellaneous functionalities of the payment processing system 101. It will be appreciated that such aforementioned modules 209 may be represented as a single module or a combination of different modules.

In some non-limiting embodiments, the displaying module 219 may be configured for displaying a list of plurality of merchants 103 to a user 105 for receiving a user selection 107 on at least one of the plurality of merchants 103 for performing one or more transactions. Similarly, the displaying module 219 may be configured for displaying a list of plurality of merchants 103 to a user 105 for receiving a user selection 107 on at least one of the plurality of merchants 103 for deleting one or more payment methods 213 set to the plurality of merchants 103. As an example, the displaying module 219 may display the list of plurality of merchants 103 on a user device associated with the user 105.

In some non-limiting embodiments, the authenticating module 221 may be configured for authenticating the user 105, based on user details 211 provided by the user 105, for authorizing the user 105 to set one or more payment methods 213 and/or to delete the one or more payment methods 213 for the at least one of the plurality of merchants selected by the user 107. In some non-limiting embodiments, the authenticating module 221 may receive the user details 211 from the user 105. As an example, authenticating module 221 may authenticate the user 105 based on preregistered biometric impressions of the user 105. In some non-limiting embodiments, the authenticating module 221 may be configured to receive details related to the one or more payment methods 213 set by the user 105 from the user 105 and validate the one or more payment methods 213 based on the details 213. In some non-limiting embodiments, when the user 105 updates the details related to the one or more payment methods 213, the authenticating module 221 may be configured to dynamically revalidate the one or more payment methods 213 to update the changes in the details related to the one or more payment methods 213.

In some non-limiting embodiments, the transmitting module 223 may be configured for transmitting the user details 211, user authorization and the one or more payment methods 213 set by the user 105 to a payment processor 109 associated with each of the plurality of merchants selected by the user 107. Similarly, the transmitting module 223 may be configured for transmitting the user details 211, user authorization and the one or more payment methods 213 to be deleted to a payment processor 109 associated with each of the plurality of merchants selected by the user 107.

In some non-limiting embodiments, the receiving module 225 may be configured for receiving a merchant confirmation on acceptance of the one or more payment methods 213 set by the user 105 from the at least one of the plurality of merchants selected by the user 107. Similarly, the receiving module 225 may be configured for receiving a merchant confirmation on deletion of the one or more payment methods 213 from the at least one of the plurality of merchants selected by the user 107.

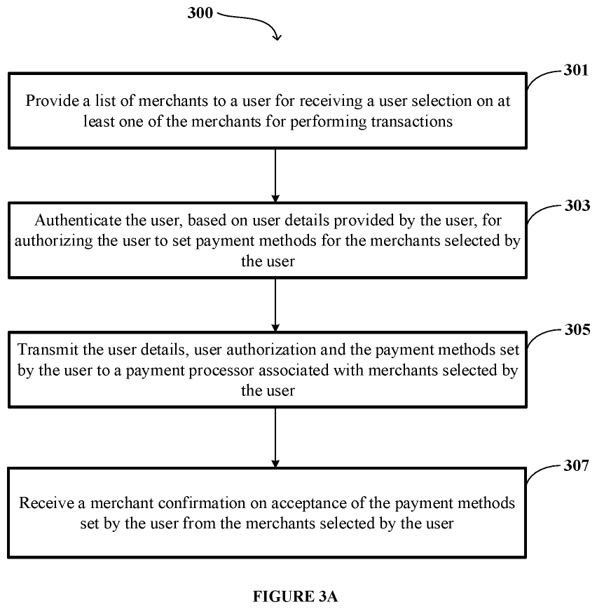

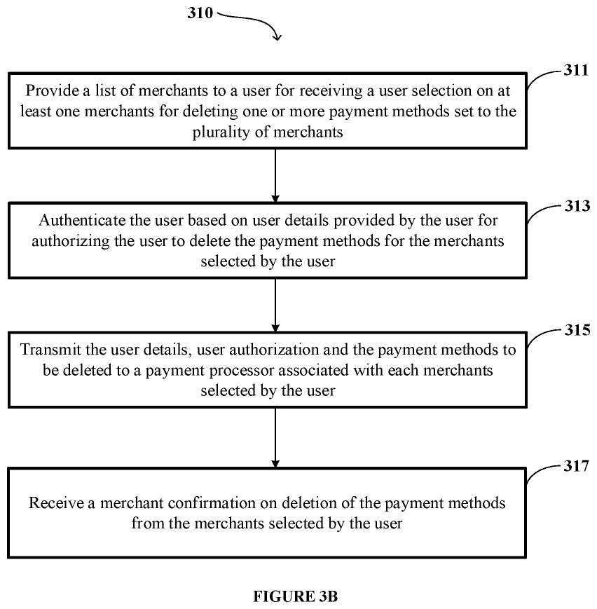

FIG. 3A shows a flowchart illustrating a method for automatic payment method transmission to merchants, in accordance with some non-limiting embodiments of the present disclosure.

The order in which the method 300 is described is not intended to be construed as a limitation, and any number of the described method blocks can be combined in any order to implement the method 300. Additionally, individual blocks may be deleted from the methods without departing from the spirit and scope of the subject matter described herein. Furthermore, the method 300 can be implemented in any suitable hardware, software, firmware, or combination thereof.

At block 301, the method 300 may include providing, by a processor 203 of a payment processing system 101, a list of plurality of merchants 103 to a user 105 for receiving a user selection 107 on at least one of the plurality of merchants 103 for performing one or more transactions.

At block 303, the method 300 may include authenticating, by the processor 203, the user 105, based on user details 211 provided by the user 105, for authorizing the user 105 to set one or more payment methods 213 for the at least one of the plurality of merchants selected by the user 107. In some non-limiting embodiments, authenticating the user 105 comprises receiving details related to the one or more payment methods 213 set by the user 105 from the user 105 and validating the one or more payment methods 213 based on the details related to the one or more payment methods 213. In some non-limiting embodiments, dynamically revalidate the one or more payment methods 213 upon detecting a change in the details related to the one or more payment methods 213.

At block 305, the method 300 may include transmitting, by the processor 203, the user details 211, user authorization and the one or more payment methods 213 set by the user 105 to a payment processor 109 associated with each of the plurality of merchants selected by the user 107.

At block 307, the method 300 may include receiving, by the processor 203, a merchant confirmation on acceptance of the one or more payment methods 213 set by the user 105 from the at least one of the plurality of merchants selected by the user 107. In some non-limiting embodiments, the merchant confirmation is received when the user details 211 provided by the user 105 matches with preregistered user details 211 stored on the at least one of the plurality of merchants selected by the user 107. In some non-limiting embodiments, the merchant confirmation is generated upon successful authentication of the user 105 by the payment processor 109 associated with the at least one of the plurality of merchants selected by the user 107. In some non-limiting embodiments, the automatic payment method transmission is re-attempted for the at least one of the plurality of merchants 103 when the one or more payment methods 213 set by the user 105 is not accepted by the at least one of the plurality of merchants 103.

FIG. 3B shows a flowchart illustrating a method for automatic payment method transmission to merchants, in accordance with some non-limiting embodiments of the present disclosure.

The order in which the method 310 is described is not intended to be construed as a limitation, and any number of the described method blocks can be combined in any order to implement the method 310. Additionally, individual blocks may be deleted from the methods without departing from the spirit and scope of the subject matter described herein. Furthermore, the method 310 can be implemented in any suitable hardware, software, firmware, or combination thereof.

At block 311, the method 310 may include providing, by a processor 203 of a payment processing system 101, a list of plurality of merchants 103 to a user 105 for receiving a user selection 107 on at least one of the plurality of merchants 103 for deleting one or more payment methods 213 set to the plurality of merchants 103.

At block 313, the method 310 may include authenticating, by the processor 203, the user 105, based on user details 211 provided by the user 105 for authorizing the user 105 to delete the one or more payment methods 213 for the at least one of the plurality of merchants selected by the user 107.

At block 315, the method 310 may include transmitting, by the processor 203, the user details 211, user authorization and the one or more payment methods 213 to be deleted to a payment processor 109 associated with each of the plurality of merchants selected by the user 107.

At block 317, the method 310 may include receiving, by the processor 203, a merchant confirmation on deletion of the one or more payment methods 213 from the at least one of the plurality of merchants selected by the user 107.

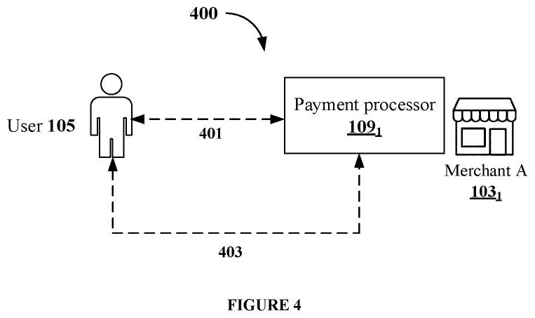

FIG. 4 illustrate an exemplary scenario of authenticating the user 105, in accordance with some non-limiting embodiments of the present disclosure. Suppose the user 105 selects a merchant A from the plurality of merchants 103 to perform one or more transactions. In some non-limiting embodiments, the user details 211 provided by the user 105 may comprise the details used to register with the merchant A (step 401). The user details 211 may be matched with preregistered user details 211 stored on with the merchant A. In some embodiment, if the user details 211 match, the payment processor 1091 associated with the merchant A may notify the user 105 and request a confirmation from user 105 (step 403). In some non-limiting embodiments, the merchant confirmation is generated upon successful authentication of the user 105 by the payment processor 1091 associated with the at least one of the plurality of merchants selected by the user 107. Upon receiving the confirmation, the user 105 may perform the one or more transactions with the Merchant A without having to once again provide the details related to the one or more payment methods 213 to the Merchant A.

In some non-limiting embodiments, when the user 105 wants to delete the one or more payment methods 213 set by the user 105 with the merchant A, the user details 211 may be matched with preregistered user details 211 stored with the merchant A. In some embodiment, after successfully matching the user details 211, the payment processor 1091 associated with the merchant A may notify the user 105 and request a confirmation from user 105. In some non-limiting embodiments, the merchant confirmation is generated upon successful authentication of the user 105 by the payment processor 1091 associated with the at least one of the plurality of merchants selected by the user 107. Upon receiving the confirmation, the payment processor 1091 may delete the one or more payment details from the payment processor 1091.

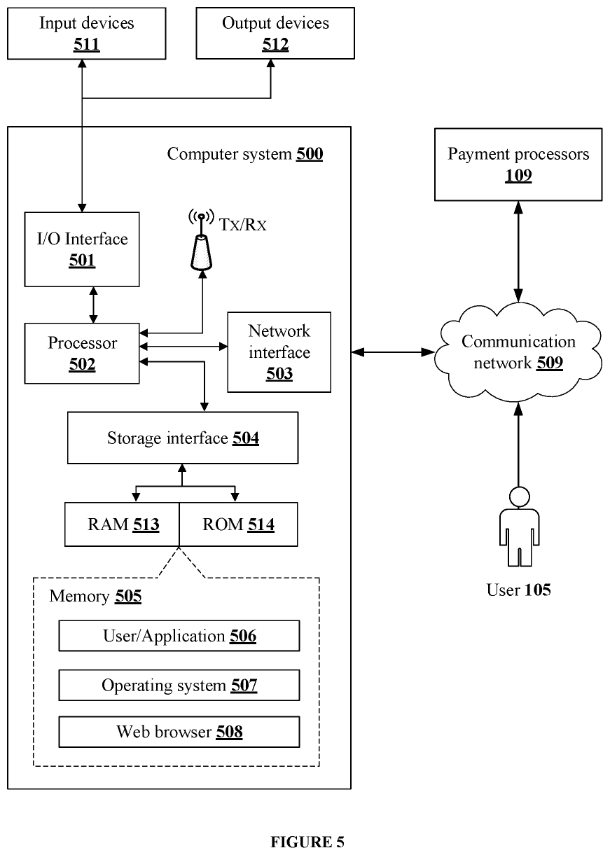

FIG. 5 is a block diagram of an exemplary computer system for implementing embodiments consistent with the present disclosure.

In some non-limiting embodiments, the computer system 500 may be payment processing system 101 that is used for automatic payment method transmission to merchants. The computer system 500 may include a central processing unit (“CPU” or “processor”) 502. The processor 502 may include at least one data processor for executing program components for executing user or system-generated business processes. A user may include a person, a person using a device such as those included in this disclosure, or such a device itself. The processor 502 may include specialized processing units such as integrated system (bus) controllers, memory management control units, floating point units, graphics processing units, digital signal processing units, etc.

The processor 502 may be disposed in communication with input devices 511 and output devices 512 via I/O interface 501. The I/O interface 501 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n /b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), etc.

Using the I/O interface 501, the computer system 500 may communicate with the input devices 511 and the output devices 512.

In some non-limiting embodiments, the processor 502 may be disposed in communication with a communication network 509 via a network interface 503. The network interface 503 may communicate with the communication network 509. The network interface 503 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 503 and the communication network 509, the computer system 500 may interface with a device associated with a user 105 and one or more payment processors 1071-107N associated with each of the plurality of merchants for automatic payment method transmission to merchants.

In some non-limiting embodiments, the communication network 509 can be implemented as one of the different types of networks, such as intranet or Local Area Network (LAN), Closed Area Network (CAN) and such. The communication network 509 may either be a dedicated network or a shared network, which represents an association of the different types of networks that use a variety of protocols, for example, Hypertext Transfer Protocol (HTTP), CAN Protocol, Transmission Control Protocol/Internet Protocol (TCP/IP), Wireless Application Protocol (WAP), etc., to communicate with each other. Further, the communication network 509 may include a variety of network devices, including routers, bridges, servers, computing devices, storage devices, etc. In some non-limiting embodiments, the processor 502 may be disposed in communication with a memory 505 (e.g., RAM, ROM, etc. as shown in FIG. 5) via a storage interface 504. The storage interface 504 may connect to memory 505 including, without limitation, memory drives, removable disc drives, etc., employing connection protocols such as Serial Advanced Technology Attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, a user interface 506, an operating system 507, a web browser 508 etc. In some non-limiting embodiments, the computer system 500 may store user/application data, such as the data, variables, records, etc. as described in this disclosure. Such databases may be implemented as fault-tolerant, relational, scalable, secure databases such as Oracle or Sybase.

The operating system 507 may facilitate resource management and operation of the computer system 500. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM®OS/2®, MICROSOFT® WINDOWS® (XP®, VISTA®/7/8, 10 etc.), APPLE® IOS®, GOOGLE™ ANDROID™, BLACKBERRY® OS, or the like. The User interface 506 may facilitate display, execution, interaction, manipulation, or operation of program components through textual or graphical facilities. For example, user interfaces may provide computer interaction interface elements on a display system operatively connected to the computer system 500, such as cursors, icons, checkboxes, menus, scrollers, windows, widgets, etc. Graphical User Interfaces (GUIs) may be employed, including, without limitation, Apple® Macintosh® operating systems'Aqua®, IBM® OS/2®, Microsoft® Windows® (e.g., Aero, Metro, etc.), web interface libraries (e.g., ActiveX®, Java®, Javascript®, AJAX, HTML, Adobe® Flash®, etc.), or the like.

In some non-limiting embodiments, the computer system 500 may implement the web browser 508 stored program components. The web browser 508 may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers 508 may utilize facilities such as AJAX, DHTML, ADOBE® FLASH®, JAVASCRIPT®, JAVA®, Application Programming Interfaces (APIs), etc. In some non-limiting embodiments, the computer system 500 may implement a mail server stored program component. The mail server may be an Internet mail server such as Microsoft Exchange, or the like. The mail server may utilize facilities such as Active Server Pages (ASP), ACTIVEX®, ANSI® C++/C #, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some non-limiting embodiments, the computer system 500 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media. In some non-limiting embodiments, processor 203 and processor 502 may be implemented in hardware, firmware, or a combination of hardware and software.

The terms “an embodiment”, “embodiment”, “embodiments”, “the embodiment”, “the embodiments”, “one or more embodiments”, “some non-limiting embodiments”, and “one embodiment” mean “one or more (but not all) embodiments” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the disclosure.

When a single device or article is described herein, it may be readily apparent that more than one device/article (whether or not they cooperate) may be used in place of a single device/article. Similarly, where more than one device or article is described herein (whether or not they cooperate), it may be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

The illustrated operations of FIGS. 3A and 3B show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the disclosure of the embodiments of the disclosure is intended to be illustrative, but not limiting, of the scope of the disclosure, which is set forth in the following claims.

While various aspects and embodiments have been disclosed herein, other aspects and embodiments may be apparent to those skilled in the art. The various aspects and embodiments disclosed herein are for purposes of illustration and are not intended to be limiting, with the true scope and spirit being indicated by the following claims.

1. A computer-implemented method for automatic payment method transmission to merchants, the method comprising:
providing, with at least one processor, a list of a plurality of merchants to a user for receiving a user selection on at least one of the plurality of merchants for performing one or more transactions;
authenticating, with at least one processor, the user, based on user details provided by the user, for authorizing the user to set one or more payment methods for the at least one of the plurality of merchants selected by the user;
transmitting, with at least one processor, the user details, user authorization, and the one or more payment methods set by the user to a payment processor associated with each of the plurality of merchants selected by the user; and
receiving, with least one processor, a merchant confirmation on acceptance of the one or more payment methods set by the user from the at least one of the plurality of merchants selected by the user.

2. The computer-implemented method of claim 1, wherein the merchant confirmation is received when the user details provided by the user matches with preregistered user details stored on the at least one of the plurality of merchants selected by the user.

3. The computer-implemented method of claim 1, further comprising generating the merchant confirmation upon successful authentication of the user by the payment processor associated with the at least one of the plurality of merchants selected by the user.

4. The computer-implemented method of claim 1, wherein authenticating the user comprises:
receiving details related to the one or more payment methods set by the user from the user; and
validating the one or more payment methods based on the details related to the one or more payment methods.

5. The computer-implemented method of claim 4, further comprising dynamically revalidating the one or more payment methods upon detecting a change in the details related to the one or more payment methods.

6. The computer-implemented method of claim 1, further comprising re-attempting the automatic payment method transmission for the at least one of the plurality of merchants when the one or more payment methods set by the user is not accepted by the at least one of the plurality of merchants.

7. A computer-implemented method for automatic payment method transmission to merchants, the method comprising:
providing, with at least one processor, a list of a plurality of merchants to a user for receiving a user selection on at least one of the plurality of merchants for deleting one or more payment methods set to the plurality of merchants;
authenticating, with at least one processor, the user based on user details provided by the user for authorizing the user to delete the one or more payment methods for the at least one of the plurality of merchants selected by the user;
transmitting, with at least one processor, the user details, user authorization and the one or more payment methods to be deleted to a payment processor associated with each of the plurality of merchants selected by the user; and
receiving, with at least one processor, a merchant confirmation on deletion of the one or more payment methods from the at least one of the plurality of merchants selected by the user.

8. A payment processing system comprising:
at least one processor; and
a memory communicatively coupled to the at least one processor, wherein the memory stores processor-executable instructions, which, on execution, cause the at least one processor to:
provide a list of a plurality of merchants to a user for receiving a user selection on at least one of the plurality of merchants for performing one or more transactions;
authenticate the user, based on user details provided by the user, for authorizing the user to set one or more payment methods for the at least one of the plurality of merchants selected by the user;
transmit the user details, user authorization and the one or more payment methods set by the user to a payment processor associated with each of the plurality of merchants selected by the user; and
receive a merchant confirmation on acceptance of the one or more payment methods set by the user from the at least one of the plurality of merchants selected by the use.

9. The payment processing system of claim 8, wherein the merchant confirmation is received when the user details provided by the user matches with preregistered user details stored on the at least one of the plurality of merchants selected by the use.

10. The payment processing system of claim 8, wherein the merchant confirmation is generated upon successful authentication of the user by the payment processor associated with the at least one of the plurality of merchants selected by the user.

11. The payment processing system of claim 8, wherein authenticating the user comprises:
receiving details related to the one or more payment methods set by the user from the user; and
validating the one or more payment methods based on the details related to the one or more payment methods.

12. The payment processing system of claim 11, further comprising dynamically revalidating the one or more payment methods upon detecting a change in the details related to the one or more payment methods.

13. The payment processing system of claim 8, further comprising re-attempting the automatic payment method transmission for the at least one of the plurality of merchants when the one or more payment methods set by the user is not accepted by the at least one of the plurality of merchants.

14. (canceled)

15. (canceled)

16. (canceled)
